(19) United States
(12) Patent Application Publication
(10) Pub. No.: US 2026/0072910 A1
(43) Pub. Date: Mar. 12, 2026

(54) QUESTION AND ANSWER SYSTEM AND METHOD

(71) Applicant: Customer Value Partners, LLC, Washington, DC (US)

(72) Inventors: Cal Ross ZEMELMAN, Falls Church, VA (US); Manpreet Singh KHURAL, Portland, OR (US); Anirudh KULKARNI, McLean, VA (US)

(21) Appl. No.: 19/316,598

(22) Filed: Sep. 2, 2025

Related U.S. Application Data
(60) Provisional application No. 63/693,941, filed on Sep. 12, 2024.

(51) Int. Cl. G06F 16/2452; G06N 3/042

(52) U.S. Cl. CPC G06F 16/24522; G06N 3/042

(57) ABSTRACT

An information retrieval and summarization system has a knowledge database that stores a plurality of data records, each having a data document ID, data document title, data source link, and data document text retrieved from the data source link. A question and answer (QA) database stores a QA ID, QA title, and an analyst-generated question and answer (QA) pair. The analyst-generated QA pair has an analyst-generated question and an analyst-generated answer associated with the analyst-generated question. A custom prompt database stores a prompt record that includes a prompt instruction, prompt clarification, and a predefined prompt example. A QA generation processing device applies the prompt record to the data document text stored in said knowledge database to generate a plurality of automated-generated QA pairs using a large language model, and store the plurality of automated-generated QA pairs in the QA database.

### BACKGROUND OF THE DISCLOSURE

Traditional Question Answering (QA) systems, have existed in various experimental forms since the 1970s and have been developed with the object of efficiently answering questions posed by users. In the realm of these traditional systems, understanding the intricate structure of human language is paramount and has proven to be technically difficult for a computing system to provide reliable and accurate answers. In many systems, each question has to be dissected into its constituent parts (e.g., syntax, semantics) to interpret the question and respond accurately. Syntax refers to the arrangement of words and phrases to create well-formed sentences in a language while semantics involves the meaning conveyed by words, phrases, and sentences. Together, syntax and semantics define the structure and meaning of questions, both traditionally necessary for a system's ability to understand that a question was being asked as well as the specific topic(s).

Prior systems often depended on rule-based engines and keyword matching, which can lead to inaccuracies and inefficiencies when dealing with the complexity and nuance of human language. More recent advances have utilized deep learning models, such as those based on neural networks, to improve accuracy by leveraging patterns learned from large datasets. However, these systems can still struggle with the breadth of human language and the subtle context-dependent meanings that questions may carry.

Until IBM Watson was demonstrated on Jeopardy in 2011, most members of the public had not seen one of these systems functioning in a useful manner. IBM Watson and similar systems of that age often relied heavily on custom programming for analysis of grammar and syntax, along with a custom knowledge base that was hand curated and very large, requiring large and fast processing capabilities. This approach did not generalize well and was largely a commercial failure. Newer solutions like Meta/Facebook's DrQA did not require as much overlapping information, but required training on the SQUAD dataset, which is 25 GB of uncompressed questions and answers. Older search-only systems often rely on manually written question and answer pairs, or are trained using large amounts of curated data. Once the question and answer pairs are configured, the system operates in an automated manner without human input. A person enters a question, either verbally or by entering text, and the automated system automatically matches the question to an existing question and answer pair, and provides the preset answer in the question and answer pair to the user.

However, such systems suffer from limited coverage as they can only answer questions where a pre-existing human-authored response is available. This leads to unanswered questions or unsatisfactory answers when requested information is not explicitly documented. In other words, these systems are inflexible due to their requirement for a close or exact match and often suffer from problems when people use synonyms, abbreviations, jargons, or are not familiar with the topic and write in generalities.

For example, in 2024, if you are interested in Medicare's coverage for a flu shot and search the CMS.gov official database for “flu”, you only receive results for items like air-fluidized beds for treating pressure sores. Because “flu” is not a medical term, you have to know to search for “influenza” to get the results a normal layperson would expect. Once you do find out the right search term, you are presented with a very long and technically complex page written with a lawyer or doctor in mind, not a 75-year-old Medicare beneficiary. See, for example, Local Coverage Determination (LCD), Immunizations, L34596, cms.gov, which is incorporated herein by reference. This limits the overall usefulness of such systems to the general public, as they must search for questions using precise technical terminology, which is often unknown or inaccessible to them as an average member of society. These keyword-based systems may work in certain scenarios, but as anyone who has spent 20 minutes searching for something on a computer and becoming frustrated has experienced, they do not work well in many cases.

Various approaches have been proposed to address these unrealistic and unscalable requirements for users to perform a precise search on question and answer pairs, including the use of semantic parsing, knowledge graphs, machine learning, and neural models. Question answering techniques have a long history of implementation comprised of two major paradigms in use since the 1960s: Information Retrieval-based and Knowledge-based. The former has become more prominent and powerful as the volume of information easily available in datasets and the internet itself through scraping has expanded rapidly. The latter was aimed to use semantic parsing to convert plain language queries into SQL queries to access a database storing many common and use-case pertinent questions.

Information retrieval began with an amalgamation of a few techniques such as tf-idf word frequency approaches combined with simple editing of the queries to remove the question words such as “who”, “what”, and “where” to simply match them to the highest scoring passages. Some systems were enhanced with supervised models that classified questions into various answer types such as “person”, “city”, etc. Overall, some form of processing would modify user queries and then send it to the retrieval engine which would search for the most relevant document and then search for the most relevant passage within it which it would perform answer extraction via techniques such as span labeling and feature-base extraction (answer type match, keyword distance, novelty factor, etc.).

As neural networks became more advanced, embedding models were able to represent passages and queries more densely and accurately tie passages to queries. Then using a reading-comprehension algorithm and Q-A datasets, they would classify passage words into high or low probability that they are the start of an answer, and if they are the end, to provide the most probable span of words to return as an answer. Generative Large Language Models (LLMs) with the brute force of model size and constraints on verbosity and redundancy, inherently capture the question-to-answer flow of language present in their internet-wide corpora of information to generate highly probable and accurate words spans as answers.

Early knowledge-based methods sought to capture the relationship between keywords of questions in columns and rows of a structured database. They mapped the questions to SQL-like representations first using rule-based approaches and then supervised models trained on datasets with prior, human mappings of questions to queries. Further improvements allowed the use of web text such as a dataset of Wikipedia articles to expand the relations captured in the database. This has evolved into hybridized methods such as IBM's Deep QA that simultaneously use the latest in both paradigms to pool the best candidate answers to put through additional stages of scoring/ranking and merging to output the most likely answer. It also provides the confidence that the system has in the answer which for LLMs is still a major challenge in instances of hallucination.

As an illustrative example, a table can contain facts about Italian cities. The table may have columns such as year, population, mayor, major industry, etc. A user may ask “What was the population of Rome in 1993?” and a knowledge-based system would use semantic parsing to write a SQL query that runs on this table. The parser may be rule based or a trained model that uses training data of user questions and SQL translations. In a more complex example, instead of just one table, it could be a whole relational database.

All of the information retrieval methodologies more or less eliminate the problem of the pairs (having to maintain a database of human created pairs, unable to grasp nuance of answer and potentially returning a wrong or irrelevant answer). Ultimately, the technical goal of QA methods is to have the highest accuracy possible while answering the question in a reasonable amount of time and in a simple way (less complex language). Improved compute and storage enabled better information retrieval techniques. Neural network architectures produced LLMs which can be trained simply on a massive corpus of text without requiring much of any human input. Models learn to create numerical representations of text embeddings which can predict words/sentences, etc. Massive generative models specifically powered by ever faster GPUs for training have the ability to understand intricacies of language through brute force (billions of parameters).

Open-source datasets allow these models to be fine-tuned to specific tasks. These models have a massive store of information which makes them fairly accurate out-of-the-box for topics they were trained on, but not for topics that are outside of this domain of trained topics. The models can also be instructed to speak in a concise and simplified language for laypersons to understand. With enough powerful hardware, the response times are fast enough for seamless interaction. The problem, specifically, is that they are not accurate enough for sensitive, technical, and out-of-domain questions.

Knowledge graphs (KG), on the other hand, represent entities and their interrelationships in a structured manner, and can be used to retrieve answers to questions. For example, a KG may have a node for Animals, connected to nodes for Cows and Dogs, indicating they are both of the type Animals. But a separate node for Herbs (which is itself linked to Plants), will be only connected to the Cow node, representing that it is herbivorous while the dog is not.

Machine learning techniques, such as supervised or unsupervised learning, have been employed to train models capable of generating answers based on patterns observed in large datasets. For example, an ML model could be trained to understand that whenever someone uses the words, “first”, “president”, and “USA” in a sentence that the answer is likely to be George Washington, but without semantic understanding of an entire sentence, it may also think “first”, “black”, “president”, and “USA” should equate to George Washington instead of Barack Obama.

More recently, neural network-based models, such as Large Language Models (LLMs), have been used to generate answers or perform natural language inference tasks. For example, the GPT 3.5 model behind the well-known ChatGPT service can successfully answer the “first black president USA” question posed in the paragraph above, but it often fails at other questions, especially those requiring complex understanding, math, or information not available on the Internet.

One notable limitation of those current automated QA systems, regardless of the underlying approach, is the potential for generating unreliable, inconsistent, or factually incorrect answers to user queries. This issue, commonly referred to as “hallucination,” can arise due to various factors, including the presence of ambiguous or unclear questions, the lack of comprehensive or accurate data sources, or the limitations of the underlying Artificial Intelligence (AI) models, as well as the general complexity of language. While new LLMs have been shown to make progress in this area, they are not fundamentally knowledge bases but are instead probabilistic word predictors. That is, they give words that are likely to meet a human's review but do not have the concept of facts. This leads not only to errors but subtle errors that sound plausible. In addition, their large size and monolithic nature as gigabytes of inscrutable weights makes fixing an “error” or adding new knowledge a process that might easily take days and kilowatts of power for training.

Another challenge in developing QA systems is the need to continually expand and update the available knowledge sources to accommodate new topics and information. Manually curating and updating these sources can be time-consuming and costly, especially for large and diverse corpora or ones that change. Consequently, there is a need for more efficient and effective methods for generating and maintaining high-quality question and answer pairs, allowing these systems to improve their performance over time without the need for extensive human intervention.

In summary, despite these numerous technical approaches, existing QA systems have limitations in terms of coverage, accuracy, and scalability. Improving these aspects is crucial for developing reliable and effective QA systems that can provide users with accurate, consistent, and comprehensive answers to their questions across a wide range of topics. For Multi-agent Retrieval-Augmented Generation (RAG), see for example, Qingyun Wu, et al., AutoGen: Enabling Next-Gen LLM Applications via Multi-Agent Conversation, arxiv.org/pdf/2308.08155, 2023. For Augment Toolkit, see github.com/e-p-armstrong/augmentoolkit. For PromptAgent, see Xingyuan Wang, et al., PromptAgent: Strategic Planning with Language Models Enables Expert-Level Prompt Optimization, arxiv.org/pdf/2310.16427, page 2, December 2023.

### SUMMARY OF THE DISCLOSURE

The present disclosure, among other things, leverages two state-of-the-art techniques: Large Language Models (LLMs) and multi-agent Retrieval-Augmented Generation (RAG). LLMs are pre-trained on vast corpuses of text, enabling them to grasp complex linguistic structures and contextualize information in a manner far surpassing previous methods. By incorporating an advanced multi-agent RAG process, our system can efficiently integrate explicit, relevant information from an external knowledge source into its responses. This approach not only addresses the limitations of prior systems, but also enhances the system's ability to provide accurate, contextually rich answers by combining the strengths of LLMs with the retrieval of specific, pertinent data.

The present solution tackles challenges to accuracy using, for example, hybridized retrieval of relevant source information, prompt optimization, auto testing via indirect, adversarial LLM that is more advanced than the live QA/chatbot LLM. Accordingly, the present solution maximizes the combination of plus points more than other existing solutions.

These and other objects of the disclosure, as well as many of the intended advantages thereof, will become more readily apparent when reference is made to the following description, taken in conjunction with the accompanying drawings.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a hardware diagram.

FIG. 2A is a block diagram showing pre-processing with Knowledge Base (KB) and question/answer generation;

FIG. 2B is a diagram showing knowledge base by topic;

FIG. 2C is a diagram showing questions by topic;

FIG. 2D is an example of a custom prompt used for creating questions and answers;

FIG. 2E shows completed instructions for QA generation;

FIG. 3A is a block diagram showing automated prompt optimization;

FIG. 3B shows an example auto prompt optimization;

FIG. 3C shows completed auto prompt optimize RAG;

FIG. 3D shows optimized prompt; and

FIG. 4 is a block diagram showing self-optimizing multi-agent retrieval augmented generation (RAG).

The figures show illustrative embodiment(s) of the present disclosure. Other embodiments can have components of different scale. Like numbers used in the figures may be used to refer to like components. However, the use of a number to refer to a component or step in a given figure has the same structure or function when used in another figure labeled with the same number, except as otherwise noted.

### DETAILED DESCRIPTION OF THE DISCLOSURE

In describing the illustrative, non-limiting preferred embodiments of the disclosure illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments of the disclosure are described for illustrative purposes, it being understood that the system may be embodied in other forms not specifically shown in the drawings.

### System Architecture

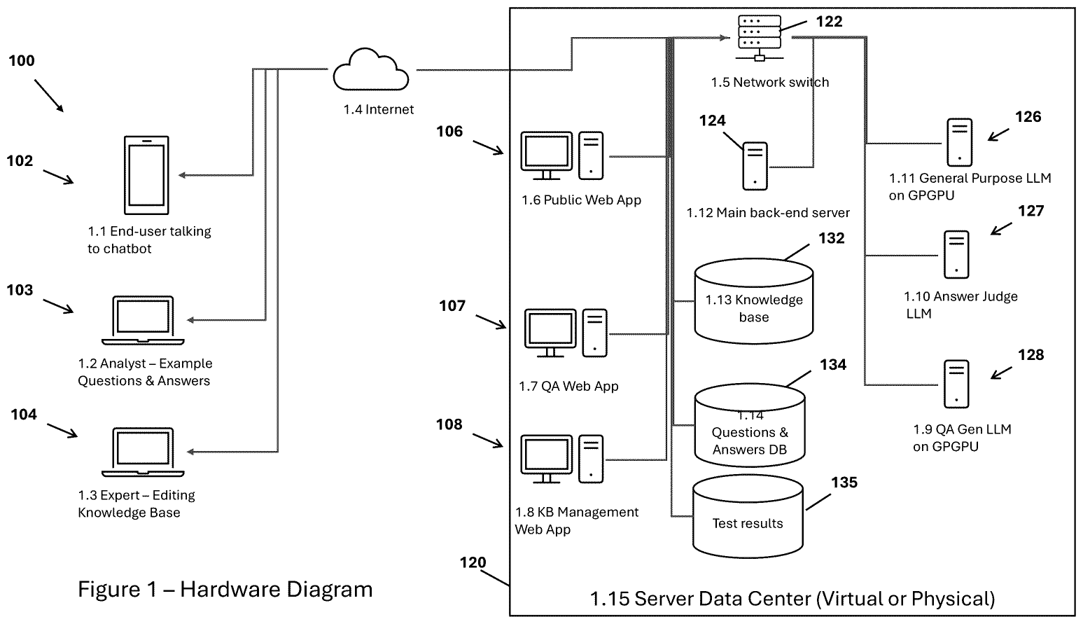

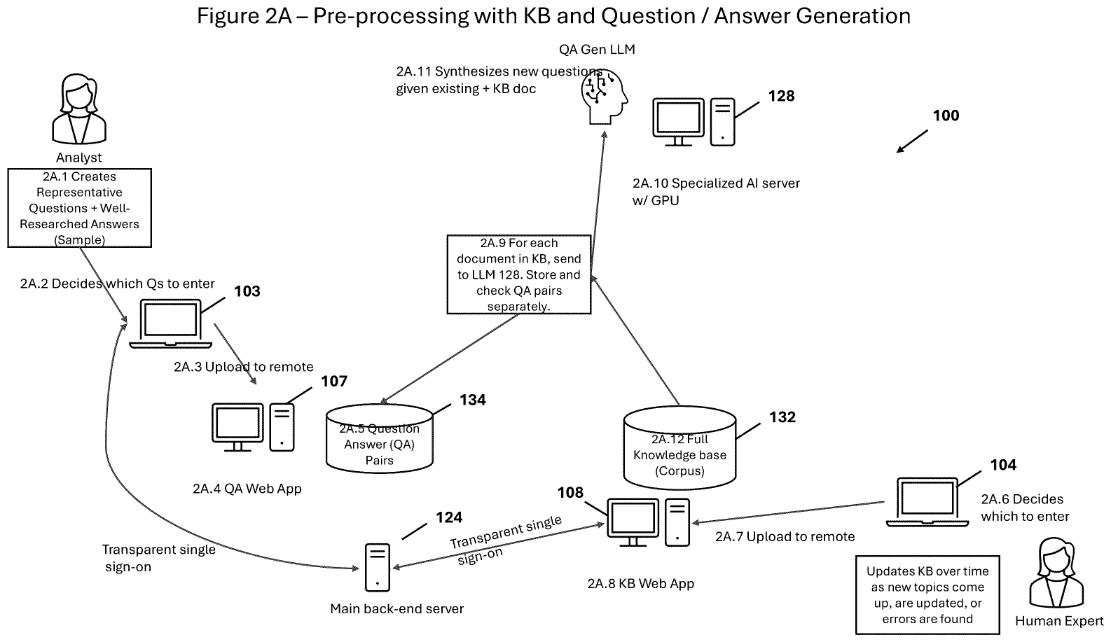

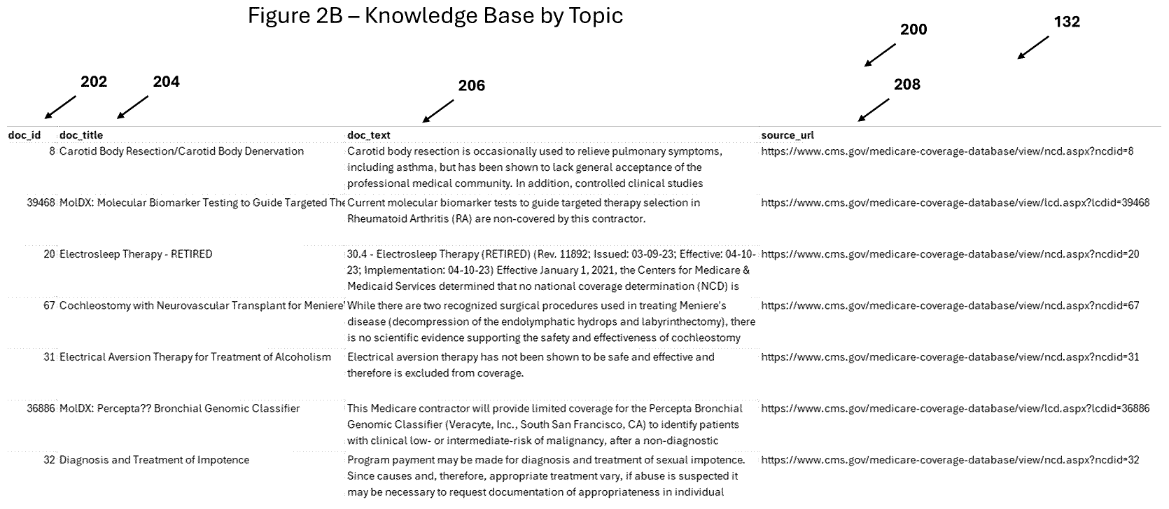

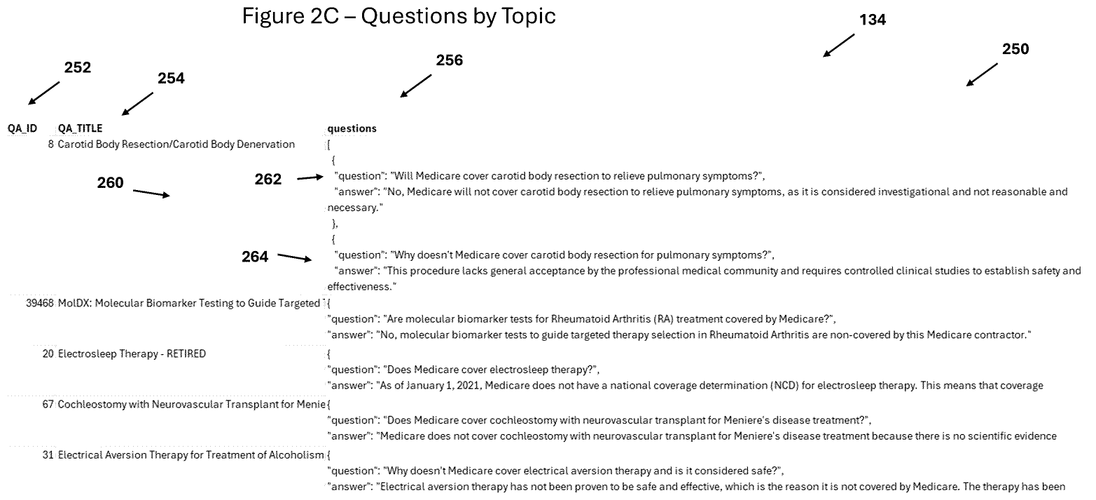

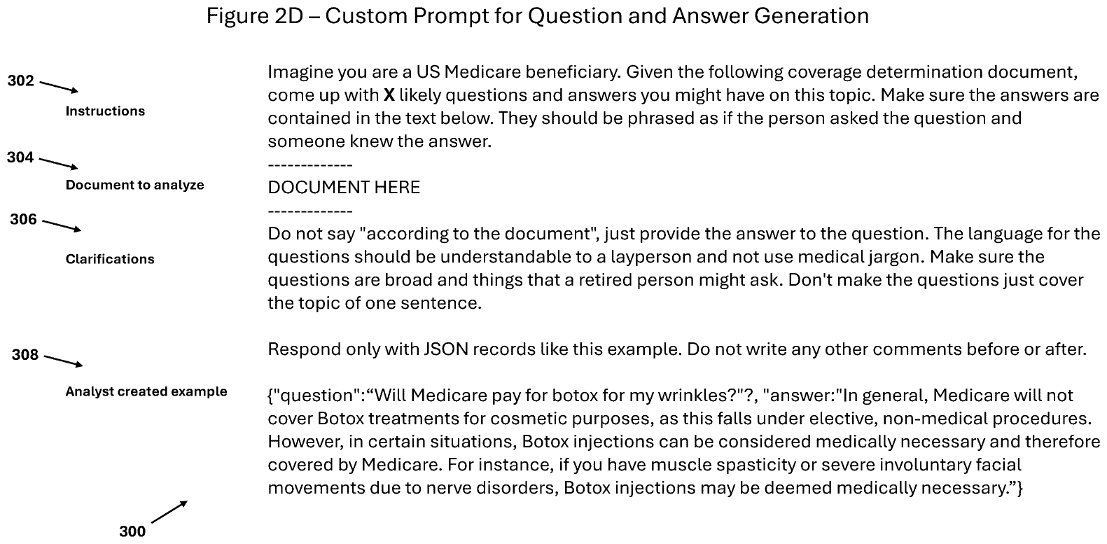

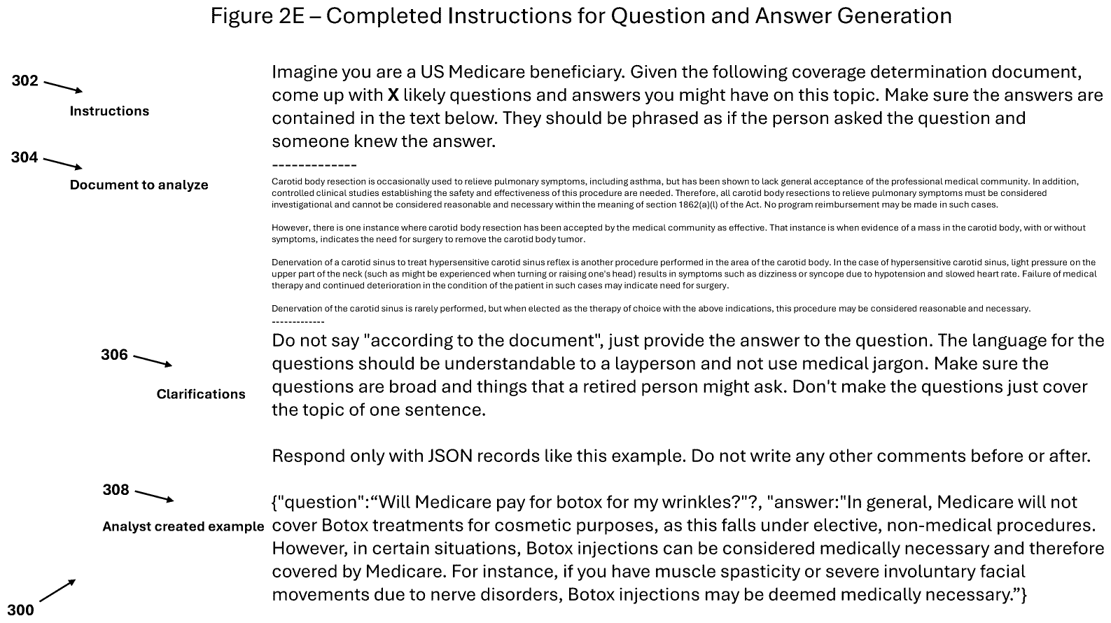

Turning to the drawings, FIGS. 1, 2A show an example embodiment of the hardware architecture depiction of the system 100. The system 100 can be any suitable information retrieval and summarization system, such as a question and answer system or a search and retrieval system. The system 100 includes at least three types of users, namely an end-user, an analyst-user, and an expert-user. In one embodiment, the analyst-user is a different person than the expert-user. For example, the analyst, as used herein, can be a supervisor at a contact center who is good at answering questions and might write an FAQ for lower-level employees, but they do not make policy; they explain it. They are more in tune with what people ask and they help write questions and answers. Conversely, the expert-user is a policy and legal expert who is the one updating the core knowledge base of the organization. In a healthcare insurance company, this expert might be a lawyer and a doctor who collaborate to update the official coverage documents.

Accordingly, the system 100 has an end-user interface/processing device 102 for the end-user to enter questions to be answered by the system 100, an analyst-user interface/processing device 103 for the analyst to enter example questions, and an expert-user interface/processing device 104 for the expert-user to update the base knowledge, and a server data center 120. The server data center 120 has a main back-end server 124 which coordinates user traffic, a GPGPU 126 having a general purpose LLM 1.11, specialized GPGPUs 127, 128 having specialized LLMs 1.10, 1.9, a Knowledge Base (KB) 132, an Information Retrieval and Summarization database, such as for example a Question & Answer database (QA DB) 134, and a test results database 135.

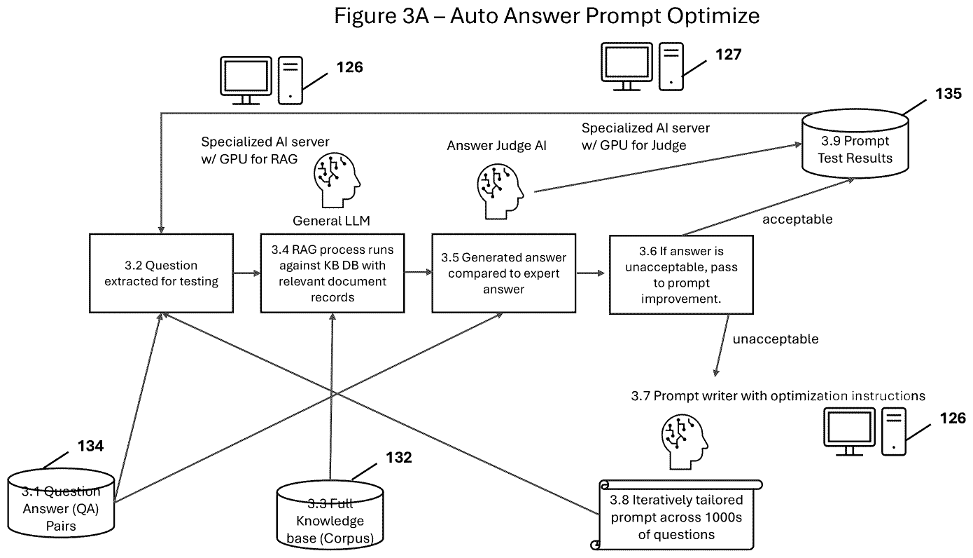

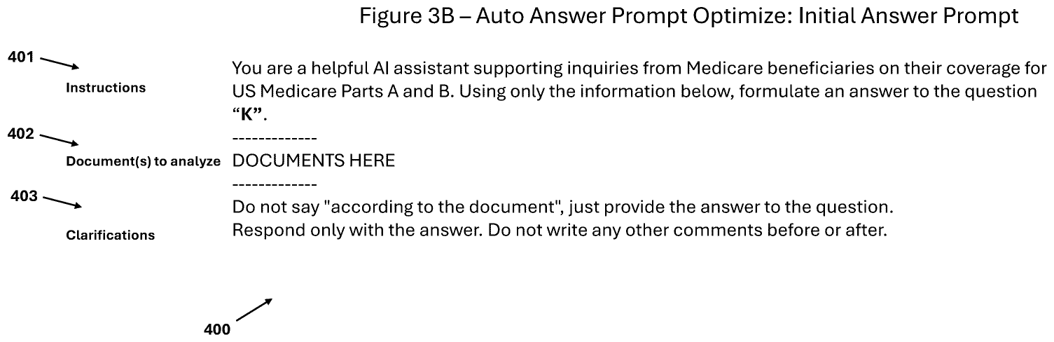

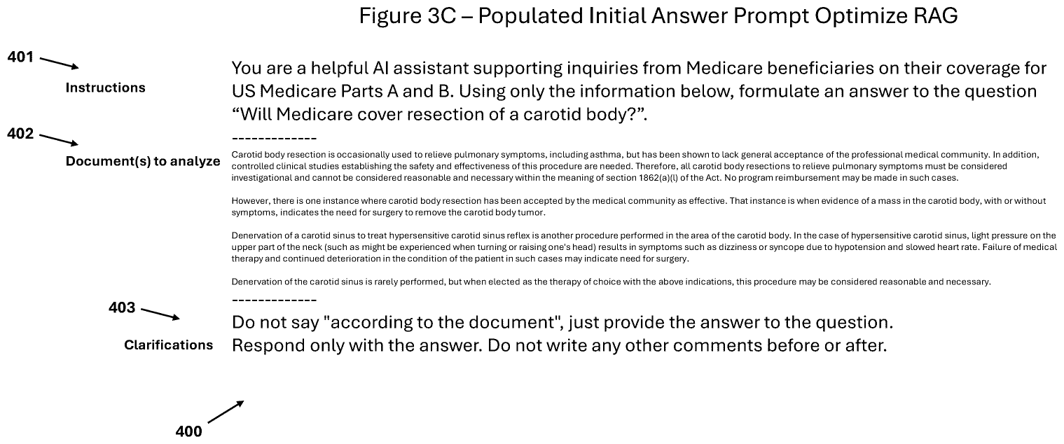

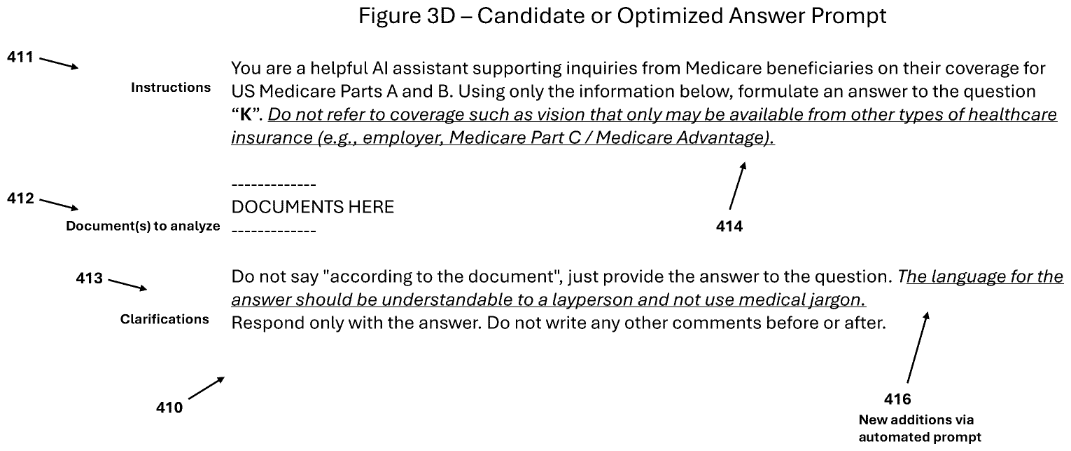

The knowledge base 132 serves as the authoritative source of information that the system 100 will use to answer questions and serves as an authoritative guide, reference manual, or similar compilation of documents that covers a series of related data in long form prose that are relevant to the topic (i.e., Medicare in the example embodiment shown in FIGS. 2B-2E, 3B-3D). The KB 132 stores QA-relevant data that can be obtained from various sources (e.g., manuals, websites, FAQs), including document title and text. The QA-relevant data is relevant to the specific application. In the example of FIG. 2B, which is discussed more fully below, the questions and answers are about Medicare coverage, and the document text stored in the KB 132 can be, for example, Medicare coverage information for various medical conditions. The QA DB 134 are QA-relevant QA pairs, which are analyst-generated and automatically generated. In the example of FIG. 2C, the QA pairs stored in the QA DB 134 relate to Medicare coverage issues.

It will be apparent that other suitable architectures can be utilized, other than as shown. For example, the QA generation LLM server 128 and the Answer judge prompt writer LLM server 127 can both be implemented at the QA server 128, and the general purpose LLM server 126 can be implemented at the main server 124. Or, a single server, such as the main server 124, can be provided that implements all of the servers 124, 106, 107, 108, 126, 127, 128.

In the example of FIG. 1, the end-user interface, analyst-user interface and expert-user interface can each be a simple end-user processing device 102, analyst-user processing device 103, and expert-user processing device 104, respectively, each capable of accessing a web application and a network. The end-user, analyst-user, and expert-user, each uses the end-user processing device 102, analyst-user processing device 103, and expert-user processing device 104, to respectively connect over the public Internet to the server data center 120, which can be a physical data center or a virtual data center. Internally, the data center has network switches 122 which connect together a number of specialized servers 106. The users must first authenticate, such as for example by entering the user account ID and password, and are all interacting with different subsystems of the same system of system. The account ID is associated with the user type and identifies the access given to each user to perform different roles and privileges. For example, the analyst-user is given access to modify the QA database 134, and the expert-user is given access to modify the KB database 132. The account information can be stored, for example, on the main back-end server 124, or at a database in communication with the back-end server 124.

By defining an analyst-user and a separate expert-user, the system 100 enables each user to provide input specific to that user's specialized knowledge and expertise. That is, the analyst-user is knowledgeable about interacting with users and can respond to questions; so the system 100 enables the analyst-user to define, review, and edit questions in the QA database 134. But the analyst-user is not especially knowledgeable about the legal or medical issues addressed by the source documents to which those questions pertain; and so the system 100 does not permit the analyst to modify the KB database 134.

In addition, the expert-user is knowledgeable about the source documents to which the questions pertain, so the system 100 grants the expert-user permission to modify the KB database 134. But the expert-user is not knowledgeable about customers or the question and answer process, so the system does not permit the expert to enter questions or modify the QA database 134.

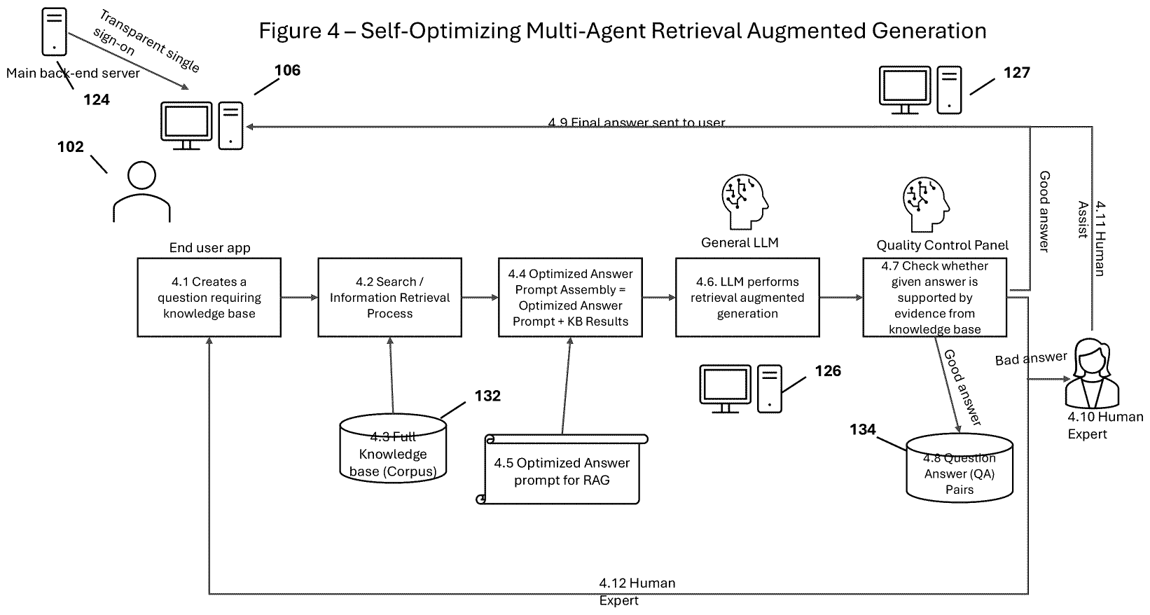

The end-user at the end-user processing device 102, step 1.1, is primarily connecting to the public web app, step 1.6, at the public web app server 106, via the internet, step 1.4, and the switch 122, step 1.5. The public web app server 106 hosts the “front-end” of the application and processes questions from the end-user. The web app server 106, in turn connects, via the switch 122, to the main back-end server 124 where the optimized information retrieval and augmented generation process (FIG. 4) happens. The main back-end server 124 retrieves information from the knowledge base 132 by sending network traffic through the network switch 122 and the KB server 108, and receiving via the same path. The server 124 then assembles and formats a prompt, which it sends via network switch 122 to the general purpose LLM 1.11 at the general purpose processing device 126. The server 126 runs the inference process so that the general purpose LLM 1.11 returns the formatted response to the back-end, which checks it with the Answer Judge Prompt Writer LLM 127 that serves both as initial judge and the prompt writer. If the back-end server 124 decides the answer is satisfactory, it passes the response back to the network switch, out of the data center, over the Internet and back to the end-user 102. This would also create a new record in the QA DB 134. At the beginning of the system setup and then over time, a help desk analyst may use an analyst processing device 103, step 1.2, to review the example questions available. The analyst processing device 103 connects to a network, via the Internet, step 1.4, to the data center 120, step 1.15, and network switch 122, step 1.5, and to the Question & Answer web app, step 1.7, at the QA server 107, step 1.7. The QA server 107 accesses QA data from the QA database 134, step 1.14, via the network switch 122, and displays, via the same path, all the existing questions and answers at the analyst processing device 103, for the analyst to review, update, or delete.

A human expert on the topic (i.e., Medicare in the example of FIGS. 2B-2E, 3B-3D) uses the expert processing device 104, step 1.3, to connect, over the Internet, step 1.4, to the data center 120, step 1.15, and the network switch 122, step 1.5, to the knowledge base management web app, step 1.8, at the KB server 108. Here the expert can review the authoritative information (e.g., an electronic manual) that is used to provide answers to the main back-end server 124. They can also choose to kick off a new automated prompt optimization process (FIG. 3A), at which point the KB management app, step 1.8, at the KB server 108 would connect to the QA DB 134, step 1.14, the knowledge base 132, step 1.13, the QA generation LLM 128, step 1.10, and/or the judge LLM 127, step 1.10, all via the network switch 122, to first generate more questions, then run the augmented generation process on the main back-end server 124, and run them through the respective LLMs 1.11, 1.10, 1.9 at the respective LLM processing devices 126, 127, 128, to improve the prompt 300 (FIG. 2D).

### Operational Overview

In pre-processing operation, referring initially to FIG. 2A, a human analyst at an analyst processing device 103, generates a first set of QA pairs, here shown as analyst-generated QA pairs 262, that are stored in the QA DB 134 (FIG. 2C), steps 2A.1-2A.5. A human expert at an expert processing device 104 reviews and edits document records 200 stored in the KB DB 132, steps 2A.6-2A.8, 2A.12 (FIG. 2B). A QA prompt 300 (FIG. 2D) is used by the public server 106 to automatically and dynamically generate multiple (perhaps thousands) of second set of QA pairs, here shown as automated-generated QA pairs 264, based on the analyst-generated QA pairs 262 and the document records 200, steps 2A.9-2A.11. The QA generated LLM 1.9 receives the prompt 300, inserts document text from the KB DB 132 into the prompt 300, and sends the populated prompt 300 (FIG. 2E) to the general purpose LLM server 126. The general purpose LLM 1.11 receives the populated prompt 300 and generates the automated-generated QA pairs 264 that are then stored in the QA DB 134.

The system uses an initial answer prompt 400 (FIGS. 3B, 3C) to evaluate the questions in the QA pairs 260, and how well those questions provide accurate answers. An optimization process (FIG. 3A) improves the initial answer prompt 400 to provide an optimized answer prompt 410 (FIG. 3D).

At this point, the pre-processing of FIGS. 1-3 is sufficient to enable the system to accept end-user questions, though the processing of FIGS. 1-3 can continue even after the end-user starts asking questions.

Turning to FIG. 4, the end-users submit questions. The system uses the optimized answer prompt 410 to conduct a search of the KB DB 132, and derive an answer.

### Analyst-Generated QA Pairs 262 (FIG. 2A; Steps 2A.1-2A.5)

Referring to FIG. 2A, the operation begins (before end-user usage) with the assembly of common question and answer pairs 262 that are then stored in the QA DB 134 (FIGS. 1, 2C) along with the knowledge base 132 (FIG. 2B). To build the QA DB 134, a human analyst (e.g., a level 2 or level 3 help desk personnel) at the analyst processing device 103, creates a list of representative questions that would be helpful for the system to be able to answer, step 2A.1. The analyst-user is a person who knows common questions and how to answer them, though they do not necessarily need to be a recognized expert on the topic. Their role as an analyst authorizes them to update questions and answers but not the core knowledge base. They enter these into a web site rendered on their own processing device 103, step 2A.2, as there may be multiple analysts doing this action concurrently. The analyst (and the expert) must be authenticated by the main back-end server 124, which also helps route users to the right subsystem.

The analyst does not blindly enter questions, but instead reviews which questions may already be present in the QA DB 134, to avoid confusion with duplication. As they enter the QA data, it is uploaded, step 2A.3, over a network 1.4 (FIG. 1), and via the switch 122 and the backend server 124, step 2A.4, to the QA web application 1.7 at the QA server 107. The QA web app at the QA server 107 then stores the QA data in the QA DB 134, step 2A.5. The QA server 107 runs both the web application, 1.7, 2A.4, as well as hosts the QA database 134, for the question and answer pairs. The QA database 134 may optionally be stored on a separate server from the web application, as is common with large databases.

An example would be the process for setting up the system to answer questions on specific topics. As one example, the system 100 can be used for answering questions on Medicare's coverage for various medical procedures, such as carotid tumors. Carotid body tumors are rare growths near the carotid arteries in the neck that are usually benign and can be dangerous to operate on due to their location near an artery that can bleed profusely. Medicare does not cover the procedure, even though it is relatively easy to find information online about the surgery, thereby misleading one to believe that the procedure could be covered.

Thus, the analyst 103 enters an initial limited set of example analyst question and answer pairs 262 that should be representative of real-world questions and their proper answer. For example, the analyst at the analyst device 103 prepares one or more QA pairs 262. The analyst device 103 stores those QA pairs 262 and sends them to the QA server 107, which then saves those QA pairs 262 to the QA database 134. The analyst 103 only needs to enter a limited number of QA pairs, for example two dozen (24) example questions QA pairs, almost all about Medicare's coverage of durable medical equipment (DME), which was that analyst's 103 primary area of experience. One of the initial example analyst QA pairs 262, is shown in the top row of FIG. 2C, and stored in the QA database 134.

Turning to FIG. 2B, the knowledge database 132 stores information or data records 200, such as document records, including related to carotid tumors. The document data 200 includes a number of document fields, including for example, a data source document ID 202, data source document title 204, data source document text 206, and the data source location 208 (e.g., website URL). As shown, the first row in the database 132, has a data source document ID (doc_id) 202 of 8, and data source document text 206 of “carotid body resection is occasionally used . . . ”, and a source of “https:///www.cms.gov . . . ncdid=8”. In the example embodiment of FIG. 2B, the document text 206 can be the entirety of the LCD, Immunizations, L34596, cms.gov, though is only partly shown in FIG. 2B for illustrative purposes. The doc ID 202 can be any suitable text, such as randomly generated or a policy number or some other text that relates to the document title and recognized by an analyst and/or expert, and can be assigned when the data is entered into the KB DB 132.

### Building the Knowledge Database 132 (FIG. 2A, Steps 2A.6-2A.8)

Referring to FIG. 2A, at steps 2A.6-2A.8, 2A.12, a human expert-user (that may or may not be the same person as the analyst) performs a separate duty of deciding what the contents of the knowledge base 132 should be. This can occur before, after, or concurrently with the analyst generating QA pairs, steps 2A.1-2A.5, and the system generating automated-generated QA pairs, steps 2A.9-2A.11, though in some embodiments QA pairs are only generated after there is some data in the KB DB 132. The knowledge base 132 serves as the authoritative source of information that the system 100 will use to answer questions and serves as an authoritative guide, reference manual, or similar compilation of documents that covers a series of related topics in long form prose. The long form prose is the typical way that a complex document that must stand up to legal scrutiny is written, even if it is not easy to understand for a non-expert in the field.

Thus, at step 2A.6 (FIG. 2A), the expert at the expert processing device 104 first authenticates themselves to the back-end 124 and then creates and/or updates this knowledge base (KB) 132 as it exists in a web application. FIG. 2B shows an example of the KB 132, while FIG. 2C shows the same topics after the process in FIG. 2A has run to automatically generate automated-generated questions and answers. In FIG. 2B, the KB 132 can be viewed as very large spreadsheet representation of what is stored in the database 132. In the example shown, each row represents one topic or chapter of the KB, and has a unique KB doc ID 202, KB doc title 204, KB doc body text 206, and KB source identifier 208, such as a link to the original source of the information. Each row represents a distinct topic of knowledge, or can be thought of as a chapter, section, or pamphlet on an entire corpus (body) of knowledge. The doc_id 202 is a unique identifier for that source document for organization purposes. The doc_title 204 is the title of the source document, similar to the title of a chapter of a textbook. The doc_text 206 is the text that explains the topic. In this example, this text is the verbatim coverage limits for Medicare on a certain disease or therapy, Carotid Body Resection. The source_URL contains a link to where the information was retrieved, which is important for data provenance purposes and is also explicitly shown to the end-user so they understand where the data is coming from.

The documents are the authoritative source of information. For an insurance company, that might be a very long coverage document. But people don't read these long documents; instead they ask questions and get answers. The entirety of those documents are stored in the KB 132, though only a portion is shown in FIG. 2B for illustrative purposes. As depicted on FIG. 3A, we are preparing to optimize the system's back-end (i.e., the prompt), resident on the main back-end server 124 on the QA pairs, after the QA pairs were generated from the source documents.

The authenticated (via the back-end server 124) expert reviews, at the expert-user processing device 104, the current documents or records 200 in the KB 132 and edits the KB 132, via the KB management web application 1.8 at the KB management server 108. For example, the expert device 104 sends a request to the KB server 108, the KB server 108 retrieves one or more of the documents 200 from the KB database 132 and sends them to the expert device 104 for display and editing by the expert-user. Any edits are then transmitted from the expert device 104 to the KB server 108, and the KB server 108 saves those edits to the KB database 132. For instance, the expert can add, update/modify, or delete one or more of the data records 200 on their computer 104 to make updates to fields 202, 204, 206, or 208 as policy changes.

For example, in 2023 Medicare extended coverage of colorectal exams from the age of 50 down to the age of 45, which would necessitate a small update to the document text 206. Either the expert knows they need to update certain documents (like an organization needs to update their standard operation procedures over time based on policy changes) or a computer program resident on 104 can be enabled that automatically checks for KB edits from an external source. Regardless of the source (a person or automated updates), those edits are temporarily saved on their computer 104 and then transmitted over a network, step 2A.7, to the centralized KB server 108. It is noted that multiple experts may be updating the KB (corpus of documents) database 132, concurrently.

The KB app 2A.8 at the KB server 108, processes this information and stores it in the KB database 132, step 2A.12, which may be optionally hosted on another server if size warrants. If a KB update is performed, any associated QA pairs in 134 are deleted and the analyst is signaled when they login on 103 that a document is missing QA pairs. Thus, for example, the KB server 108 can be manually updated or updated automatically, e.g., continually or periodically (daily/weekly/monthly) scanning the source 208, performing a comparison for updated information and then updating the document text 206 in the KB 132. When the doc text 206 is changed, the QA pairs for that document (e.g., based on the doc ID 202), are updated or deleted and the analyst has to regenerate them.

### Automated-Generated QA Pairs 264, Steps 2A.9-2A.11

The present system 100 takes each document record 200 from the KB DB 132 and dynamically generates one or more computer-generated or automated-generated QA pairs 264. This can occur before, after, or concurrently with the expert building the KB database 132, steps 2A.6-2A.8, 2A.12, and can be in real time. FIG. 2C shows details of QA records 250 stored in the QA database 134. Each record 250 has a number of QA fields, including for example, a QA ID 252, QA title 254, and QA pairs 256. The QA pair field 256 stores a plurality of QA pairs 260, which includes analyst-generated QA pairs 262, and automated-generated QA pairs 264. In the example embodiment shown, the QA ID 252 is the same as the knowledge base document source ID 202 (in the example shown, both IDs are the numeral 8). The QA ID 252 and/or the doc ID 202 can be randomly generated or related to the particular application topic (here Medicare), or based on the document (such as page number or chapter number), date, etc.

In this manner, the expert-user can use the data source document ID 202 from the KB database 132 and automatically be shown a matching QA ID 252 in the QA database 134 to find the QA pairs 260 associated with that document source 208 and document source text 206. In addition, the analyst-user can start with the QA ID 252 and the system will join or link to the matching data source ID 202 in the KB database 132 to identify which source documents 206 are associated with that QA pair 260. Thus, while the expert-user cannot modify the QA database 134, the expert-user can view the QA pair 260 in the QA database 134 that are associated with the source documents 206 and URL 208 in the KB DB 132. And while the analyst-user cannot modify the KB database 132, the analyst-user can view the source documents 206 and URL 208 in the KB DB 132 that are associated with the QA pair 260 in the QA DB 134.

The doc ID 202 in database terms is called the “primary key” of the table 200 and uniquely identifies a document. In FIG. 2C, the QA database 134 represents a child table, where the QA ID 252 is a foreign key to the same document. Using standard SQL joins in the database, the system can associate each document with the corresponding question(s) and answer(s) used during the processes depicted on FIG. 2, FIG. 3, or FIG. 4.

To start, as noted with respect to steps 2A. 1-2A5 above, the analyst 103 has entered an initial limited set of example analyst question and answer pairs 262 that are stored in the QA database 134. These initial sets of example analyst-generated QA pairs 262 are used as examples to generate automated-generated QA pairs 264. To do so, the QA generation LLM 1.9 at the QA generation server 128, analyzes the original text of the documents residing in the KB database 132 (e.g., the first entry in the example of FIG. 2B being carotid body coverage). The QA generation LLM accelerated server 128, uses the initial analyst-generated questions in the QA database 134, to automatically and dynamically create thousands of automated-generated question and answer pairs 264. The process can run continually at predetermined times (e.g., hourly daily, weekly), or at predetermined conditions (e.g., modification, addition, or deletion of a document record 200).

As shown in FIG. 2D, a QA customized prompt 300 is stored at the QA server 107. The prompt 300 can be a Retrieval-Augmented Generation (RAG) prompt, which generally used with an LLM alongside results from a search (i.e., a retrieval) to get a better ultimate response. The QA prompt 300 is configured to cause an LLM (here, the general purpose LLM 1.11) to generate the automated-generated QA pairs 264 based on analyst-generated QA pairs 264, for each document record 200 stored in the KB DB 132. As illustrated in FIG. 2D, the prompt instruction can be, for example, to “imagine you are a US Medicare beneficiary. Given the following coverage determination document, come up with X likely questions and answers pairs you might have on this topic.” The prompt 300 contains prompt instructions 302 and QA pair requirements. In the example embodiment of FIG. 2D, the prompt record 300 can include one or more prompt fields, including prompt instructions 302, prompt document to analyze 304, prompt clarifications 306, and prompt analyst-generated example 308. FIG. 2D illustrates a single prompt template which runs for one document to analyze 304 and generates one or more QA pairs 264 based on the instructions 302, clarifications 306 and using the analyst-generated QA pair 262 as an example 308. The QA server 107 instructs the QA server 128 to run the prompt 300 for each of the document records 200 stored in the KB DB 132, each time substituting in a different document 206 at the “document to analyze” field 304.

In the example embodiment shown in FIGS. 1-2, the QA web app 1.7 at the QA server 107 instructs the LLM model 1.9 at the server 128, step 2A. 10, to run the QA prompt 300. The QA generation LLM 1.9 receives the QA custom prompt 300 (FIG. 2D) from the QA web app 1.7 at the QA server 107. It also receives the text of an example analyst-generated QA pair 262 (or a previously automated-generated QA pair 264) retrieved by the QA server 107 from the QA DB 134, and puts it into the prompt 300 at the analyst create example field 308. The QA pairs can be selected in order, randomly, or based on some other criteria. The LLM 1.9 also receives the doc text 206 (the text of the policy) from one of the document records 200 in the KB DB 132 via the DB server 108, and puts that into the prompt 300 at the document to analyze field 304. The entire completed prompt 300 (FIG. 2D) is then sent to the general purpose LLM 126. The general purpose LLM 126 runs the prompt and sends back text that is stored as an automated-generated QA pair 264 in the QA DB 134 (FIG. 2C), such as via the QA server 107. In other words, the LLM 126 reads the document identified as the document to analyze field 304, follows the prompt instructions 302, clarifications 306, and the analyst created QA pair example 308, and dynamically generates the automated-generated QA pairs 264. It continues that for each document record 200 in the KB DB 132.

In some embodiments, such as illustrated by the present figures, the system 100 is set up for a single topic (i.e., Medicare in the example of FIGS. 2B-2E, 3B-3D). Accordingly, all the document records 200 relate to the prompt instruction and the prompt runs on all of the document records 200 in the KB DB 132. It will be recognized that the system 100 can be utilized for any suitable application. For example, for an FDA (Food and Drug Administration) application, the KB DB 132 would be populated with rules relevant to FDA issues. Of course, the KB DB 132 can have documents for more than one topic (e.g., both FDA and Medicare document records 200) or to cover sub-topics, and those records can be maintained separately or otherwise categorized by category or topic so that a first topic prompt (i.e., Medicare-related prompt) is run on the first topic records 200 (i.e., Medicare-related records), and a second topic prompt (i.e, FDA-related prompt) is run on the second topic records (i.e., FDA-related records). For each application, the prompt instructions 302 and clarifications 306 can be customized by the expert-user and/or analyst-user (or other user) so it makes sense for that topic. In addition, the document records can be defined as being relevant to the first topic, the second topic, or both the first and second topics.

Several examples of document titles and their associated QA pairs 256 are shown on FIG. 2C, including the analyst-generated QA pairs 262 and the machine or automated-generated QA pairs 264. Each QA pair 260 is stored in the QA database 134 with a different QA ID 252. For example, many computer programming languages start counting at 0, so the carotid artery QA IDs 252 would be 8 [0], 8 [1], etc. The QA ID 252 and QA Title 254 can be used for reference by the analyst-user and/or the expert-user to see the general issue that is addressed by the document 206, 208 and/or QA pair 256.

The process 2A.9 accesses the QA pairs 260 by going to the doc_ID 202 of the document and then putting their number in square brackets to find the associated QA pairs. This is done to help the analyst see how much question coverage there and to optionally review QA pairs for accuracy. If so desired, the analyst can edit the QA pairs if a problem is found.

It can take a human about 10 minutes to enter a question and answer at the analyst processing device 103 using the QA web application 107, and store them at the QA database 134. However, the server 128 generates questions and answers, grounded in the knowledge base documents (rows in 2B), at a rate of 5 seconds per QA pair, and it can run constantly (24 hours a day, 7 days a week). These QA pairs will be used as discussed with respect to FIG. 3A below. These QA pairs will be used for several purposes, for instance as a rich set of data to objectively test the quality of answers at step 3.6; and to automatically improve the solutions internal prompts at step 3.7. This reduces hallucinations (bad answers in general) and improves overall performance.

The analyst QA pairs 262 and automated QA pairs 264 are treated equally, though in some embodiments the analyst pair 262 can be given priority over automated pairs 262, or vice versa. And, the analyst 103 unique ID can also be stored in the QA database 134 and associated with the QA ID 202, and used for auditing and/or tracking purposes to know which analyst entered which QA pair 262, and to evaluate analyst performance. As further shown in FIG. 2C, the QA pairs 260 are stored as a list (an item with more than one value), as represented in JSON format by the open and close brackets “[” and “{” under the QA pair field 256.

At step 2A.9, a specialized QA generation server 128, such as a general-purpose graphics processing unit (GP GPU), is used to run a QA generation LLM 1.9. A GPU or similar massively parallel processor is essentially required to run (perform inference) LLMs in a timely fashion, whereby on an Nvidia GPU each question takes about 4 seconds to generate a single question and answer, but could take 4 minutes on a regular CPU. For non-trivial bodies of knowledge where there could be thousands of questions, an accelerated server with a GPU makes the process feasible to test in under a week. For each document in the KB 132 (there may be thousands or more), the QA Web app 108 invokes the process of creating or augmenting the QA pairs for that document/topic.

The analyst on the analyst processing device 103, sets a target or threshold number of questions per sentence as a goal of density of the FAQ relative to the respective document text 206. This setting may be stored on their device 103 or centrally on the server 107 for consistency. It is used to calculate the number of QA pairs 260 targeted by the entire process on FIG. 2A. For example, a goal of 0.7 questions per sentence (though can be 0.5-1.0 per sentence), with a minimum of one QA pair, would mean a one or two sentence document would get one question, while a three-sentence document would get two questions (0.7*3˜=2). We have found in testing that 0.7 questions generated per sentence generates good coverage of the document, without becoming overly repetitive. If one question is required per sentence, the questions can often become reworded versions of each sentence, but if this number is too low (e.g. 0.2 questions/sentence), then certain pieces of information are missed. For a short document of only two sentences like we have in some examples, we want at least one question minimum per topic. This limit is required so that the system does not generate zero questions (which would render later processes unable to run due to a lack of data), or an infinite number of questions (which would be redundant and also make running subsequent tuning processes impossible. If the number is too high, it will be forced to come up with multiple questions per sentence, which could result in the QA pairs being redundant and unrealistic or pedantic.

At step 2A.9, the KB server 108 retrieves data from the KB database 132, and the process running on the LLM 1.9 at server 128 generates more QA pairs, step 2A.11. For example, the KB server 108 retrieves document text 206 (FIG. 2B “doc_text”) from the KB 132, and combines the retrieved document text 206 with a custom prompt 300 (FIG. 2D) to generate more questions up to the target number of questions, which was previously set at the analyst device 103 by the analyst and stored at the QA server 107 and/or at the QA database 134. The QA Gen LLM 1.9 running on the QA LLM server 128 internally determines the number of questions to generate based on the prompt 300 it was given. For example, the prompt in FIG. 2D indicates that “X” QA pairs are to be generated, and the number for X is stored at the QA server 128 and is set at run time by the process resident on the QA LLM server 128 (in an alternative embodiment, the threshold can be saved in the KB DB 132 in the respective document record 200). These QA pairs are then stored at the server QA DB 134 as automated-generated pairs 264 in FIG. 2C, step 2A.9, until the target number of questions is met. After, the pairs are sent back from the from the QA GEN LLM on the GPGPU 128, where they were generated, over the network and network switch 122 to the QA Pair database 134. A new document is retrieved from the KB 132, and the process repeats. The QA Web App server 107 repeatedly runs the process of FIG. 2A for a given topic (i.e. once per row/topic on FIG. 2B) until there are questions for each document.

The QA server 107 retrieves the document text 206 (FIG. 2B) from the KB 132. It is able to do this because the analyst has permission to view all documents and their associated QA pairs at 103 in order to complete their job, and they may notice the document in question has no questions or unsatisfactory ones. They press a button on 103 which connects to 107 and executes a “Generate Questions” command, much like a button can send an email to a coworker requesting they perform a certain task. The QA server 107 then sends the assembled prompt instructions 300 to the QA LLM at the QA GPGPU 128, with the retrieved document text 206 substituted in for the prompt document 304 to be analyzed. FIG. 2E depicts a completed or populated version of these instructions to send to the general purpose LLM server 128, with the respective document text 206 substituted into the prompt as the document to analyze 304. The QA server 107 can access the KB DB 132 directly, or via the KB server 108, and the DB server 108 can access the QA DB 134 directly, or via the QA server 107.

The QA processing device 128 is instructed via an API call from 107 to generate one or more questions that has an answer contained in the retrieved document text 206. Thus, at step 2A.9, the QA server 107 generates QA pairs for each document 200 in the KB 132. If a document is short (e.g., one sentence), then only a single QA pair might be generated.

The prompt clarifications 306 instruct the QA LLM server 128 as to how to create the question and answer terminology (e.g., to use or avoid), sophistication level (e.g., layperson vs. expert), broadness or detail level, etc. Each time the process runs, one or more automated-generated question and answer pairs are generated. The LLM server 128 returns them as a response to the API call from 107, and 107 connects to 134 to store them as the automated QA pairs 264. In one embodiment, all of the QA pairs 264 are returned from the general purpose server 126 at the same time, which avoids overlap between the QA pairs 264. In other words, computer code on the QA Web app 107 retrieves a document's body (FIG. 2B “doc_text”) from the KB 132 and then repeatedly asks the QA generator model 128 to generate another question until the target is met. It is noted that in the example embodiment, the entirety of the document text 206 from the document source 208 is stored in the KB 132. In other embodiments, the document text 206 need not be stored in the KB 132, but instead only the document source 208 is stored, and the KB server 108 can retrieve the document text as needed. Accordingly, the automated-generated QA pairs 264 are derived from one or more prompts 300 and the stored document text 206.

It is noted that, in the present example, the QA server 107 is looking to generate questions for carotid body resection (the first row of FIGS. 2B, 2C). However, the prompt example 308 provides an example for Botox. The QA generation LLM 128 uses the Botox prompt example 308 to assist it in generating a question for carotid body resection. The Botox prompt example 308 is an ideal example of what is wanted for carotid body resection questions. So, the Botox prompt example 308 can be utilized for all QA pair generation. In other embodiments, a carotid body resection analyst-generated QA pair example can be utilized when generating automated-generated QA pairs 264 for carotid body resection.

### QA Storage and Review

FIGS. 2B and 2C show the completed operation. Consider the document text 206 on the first row of FIG. 2B. This first row represents the verbatim writeup from the Medicare website at link 208, on what their coverage is for carotid body resection. The QA Gen LLM 1.9 residing on the QA processing device 128, step 2B.9, has automatically generated proposed questions and answers that Medicare beneficiaries (the end-users at end-user processing devices 102, FIG. 1) might pose in the future. As the automated-generated QA pairs are generated by the LLM model 1.9 running on the server QA generation server 128 sending the populated prompt 300 to the general LLM 1.11 at the general server 126, the automated-generated QA pairs 264 are stored in the QA database 134. FIG. 2C shows the automatically-generated questions 264 in a spreadsheet format. In the example embodiment of FIG. 2C, the QA pair column 256 contains two questions and their associated answers, including the analyst-generated QA pair 262 and the automatically-generated QA pair 264 by the process reading the document. The QA server 107 stores the analyst-generated QA pairs 262 in the same record as the automated-generated QA pairs 264. When storing and retrieving QA pairs 260, the QA server 107 does not distinguish or give priority to analyst-generated QA pairs 262 as compared to automated-generated QA pairs 264. However, in other embodiments, all the QA pairs 260 can be weighted based on a number of factors regarding confidence in the QA pair, such as for example, whether the QA pair is analyst-generated, automated-generated, based on the length of the retrieved document, and similarity to other QA pairs.

FIG. 2C is a simplified view of what the output of the above process looks like. Each record here is the same knowledge base topics as shown in FIG. 2B, but on the right side the automated process has attached one or synthesized questions and answers that were created, step 2A.9. The QA records 256 represent official question and answer pairs 260 that are used in later processes (FIGS. 3, 4) to perform other tasks. They may be human analyst generated, or automatically generated with the pre-processing step as depicted on FIG. 2A. Compare the text of data document 206 on carotid body resection in FIG. 2B to the QA pair 264 in FIG. 2C: the QA pair 264 is the same as the official statement of document 206, but now reformatted into a question that an end-user 102 might ask along with a subsequent answer they might be given based on official policy.

The human analyst at the analyst-processing device 103, after being authenticated by 124, may at any point review the question and answer pairs 260, delete unsatisfactory ones, add more, or raise the threshold for coverage such that more automated questions are synthesized, step 2A.11, if they believe it would be helpful. This is done by the analyst pressing a button on 103, which sends a command to 107 requesting an update to a record like 260 stored in 134. Thus, a single analyst 103 can instruct the overall system 120 to generate thousands or tens of thousands of questions automatically on a very broad knowledge base (body of knowledge) without having to read, consider, and then type out each question and answer. If the analyst thinks any questions are wrong or a specific piece of information is missing, the analyst-user 103 can co-mingle, delete, or edit as needed. Generally speaking, the more accurate QA pairs 260 that are stored in the QA database 134, the more thorough testing that can be performed and the better the solution can be optimized ahead of time to answer common questions with fewer wrong answers.

The doc_title 204 and the QA title 254 are analogous to a chapter title in a book (e.g., “8 Carotid Body Resection”) and is used for orienting the analyst at 103 or the expert 104 as to the subject they are looking at. The data source 208 is reference information for the expert or analyst if they ever need to direct link to the source information for reconciliation purposes. For other embodiments of the system, 208 might be a citation for a page number in a book.

### Automated Prompt Optimization, FIGS. 3A-3D

Turning to FIGS. 1, 3, once the QA pair database 134 and KB database 132 are completed to a level that the experts believe there are a sufficient number of questions to handle queries (based on the established threshold level), the servers 120 moves to the dynamic automated prompt optimization process (FIG. 3A) to implement a preliminary or initial answer prompt 400 (FIGS. 3B-3D) which can, for example, be briefly configured or predetermined by a human at system initialization. That is, the optimization process (FIG. 3A) is used to optimize the initial answer prompt 400 to generate an improved or optimized answer prompt 410 (FIG. 3D), so that the optimized answer prompt 410 can be executed on end-user questions submitted by end-users, to provide a more reliable (e.g., optimized) answer to the end-user.

The system 100 does not use a fixed Retrieval-Augmented Generation (RAG) prompt, but rather uses the previously created QA pairs 260 to automatically optimize the built-in initial answer prompt 400 for maximum accuracy, while saving new initial answer prompts 300 for future use. In other words, the system can, upon request or at predetermined times or conditions, optimizes its own initial RAG answer prompt 400 for the specific business process to improve the internal workings so that the optimized answer prompt 410 generates better answers.

At step 3.2, upon request of the analyst or expert from the processing devices 103, 104, routed through the QA server 107 or the KB server 108, the general-purpose server 126 is instructed to begin the auto-prompt optimization process. The general server 126 initiates a connection to the QA pairs database 134, step 3.1, and downloads an entire copy of all QA pairs 260 to ensure the optimization process is run across all topics. As the process may take several hours or even several days for a large set of QA pairs, it should be run whenever substantial changes to the KB 132 or QA pairs DB 134 has happened, with “substantial” up to expert determination. From the entire dataset, the general server 126 selects each QA pair 260 (either an analyst-generated QA pair 262, or an automated-generated QA pair 264), step 3.2, as a test question that could come from a user. It will eventually iterate through all QA pairs, but test and optimizes one by one.

At step 3.4, the general-purpose server 126 initiates a Retrieval-Augmented Generation (RAG) operation (FIG. 4). The general server 126 creates a connection to the KB database 132, step 3.3, which serves as the authoritative source, to search for relevant document records 200 in the KB database 132 via the server 126, which has a baseline set of instructions on how to take these sources and create an answer. The general server 126 does a very broad search to help end-users, while the QA server 107 performs create/read/update operations of the KB database 132. This process is the same as used to normally answer questions for end-users 102, as the purpose of FIG. 3A is to essentially test the end-user process repeatedly in an automated fashion. This is done both to generate answers, but also as a form of pre-test of those answers, step 3.5, before real users interact with them. One benefit is that step 3.5 running on the Answer Judge Prompt Writer LLM 1.10 at the Answer Judge server 127 will find out about problems by repeatedly seeing if it gives reliable answers to known questions by comparing a number of them to “known good” answers it has a record of, i.e., the analyst-generated QA pair 262 or the automated-generated QA pair 264.

This information is used by the general-purpose AI LLM at the general server 126 to assemble a proposed answer using any suitable RAG process, such as for example as originally defined in Lewis et al., Retrieval-Augmented Generation for Knowledge-Intensive NLP Tasks, Advances in Neural Information Processing Systems, 33, 9459-9474 (2020), which is hereby incorporated by reference in its entirety. In short, the general server 126 reviews a question originally from the QA database 134 and then initiates a network connection via the switch 122 to the KB database 132, and runs a search algorithm to locate potentially relevant documents 200 stored in the KB database 132 (e.g., data document 206 if the end-user were to ask about coverage for carotid body resections).

At step 3.4, the relevant document records 200 (e.g., the top 3, though any suitable number can be utilized) are analyzed by the initial answer prompt 400, as shown in FIG. 3B, which is stored at the general-purpose server 126. Referring to FIG. 3B, each initial answer prompt 400, stored at the general-purpose server 126, includes an initial answer prompt instruction 401, initial answer prompt document to analyze 402, and initial answer prompt clarification 403. The initial answer prompt instruction 401 is a basic set of instructions that instructs the LLM (here, the general-purpose LLM 1.11 at the general-purpose server 126) to formulate an answer to one of the questions in the QA DB 134. Accordingly, the question part of a QA pair 260 from the QA DB 134 is inserted into the initial answer prompt instruction 401. For example, as shown, the question part of the QA pair 262 (in FIG. 2C, “Will Medicare cover carotid body resection to relieve . . . ?”), is inserted into the initial answer prompt 400 for the variable Y by an LLM program 1.11 resident on the general purpose server 126.

Next, the general-purpose server 126 runs the initial answer prompt 400 on the relevant question from the QA pair 260 on all of the documents 200, e.g., one document at a time, from the KB database 132, by inserting the data document text 206 of the relevant document 200 into the initial answer prompt 400 as the initial answer prompt document 402. The populated version of the initial answer prompt 400 is shown on FIG. 3C, as populated with the question from the QA pair 262, and the document record 200 from the KB DB 132. The initial answer prompt 400 includes initial answer prompt instructions 401 that are used to set the style of the answer, and initial answer prompt clarifications 403 that further instruct the LLM 126 on how to format the answer. The entirety of the completed populated initial answer prompt 400 is sent to the general-purpose processing device 126, step 3.4. The general-purpose server 126 generates a proposed answer to the question, and temporarily stores the proposed answer in memory of the general-purpose server 126 before being sent to the answer LLM 1.10 at the answer server 127. The canonical answer (which was previously not used) is be compared to the generated answer to ascertain whether optimization is needed.

The general-purpose server 126 sends the retrieved QA pair 260, the proposed answer from the RAG process, step 3.4, and the source material document text 206, step 3.3, to the judge LLM 1.10 at the judge server 127 that runs separately and is fine-tuned for one specific task, namely to evaluate answers against a rubric. Any suitable technique can be utilized to judge the proposed answer, such as for example a model called Prometheus. See Seungone Kim et al., Prometheus: Inducing Fine-grained Evaluation Capability in Language Models, huggingface.co/Prometheus-eval/Prometheus-13b-v1.0, 2023, the content of which is incorporated herein by reference in its entirety. The answer server 127 is trained on the QA pair, proposed answer, and a scoring rubric, to return a score (e.g., 1 is for a bad answer, 5 is for a perfect answer) and a text justification, based for example on any suitable factors. This answer judge AI server 127, step 3.5, evaluates whether the question was properly answered based on the reference information supplied, i.e., the document text 206.

At step 3.6, if the proposed answer is judged to be acceptable or better than the original answer from the QA pair 262, the successful results are written to a test results database 135, step 3.9, hosted on a persistent server for later manual review. As shown, steps 3.2-3.6 repeat until all questions from the QA pairs in the QA DB have been tested at least once.

If the answer is not acceptable (e.g., wrong, off topic), step 3.6, it is stored temporarily in memory at the general-purpose server 126 and sent for prompt evolution, step 3.7. Here the same LLM model 1.11 at the Answer Judge Prompt Writer server 126, is instructed to improve the initial answer prompt 400 for the specific situation. That is, the general model 1.11 hosted on the general purpose LLM server 126 is told by the PromptAgent program at the server 126 to act as a prompt writer and given optimization instructions like “This question given this material was answered incorrectly, try modifying the prompt to ask for more detail so that the information is considered properly.” For example, PromptAgent can sample model errors (from the base model), generate error feedback (actions), try multiple variations and generate the best modification. Those modifications from the PromptAgent are then added to the answer prompt 400, as added or enhanced conditions.

For example, the server 126 modifies the initial answer prompt 400 (FIG. 3B) to add or enhance the instructions 401 to generate a new candidate answer prompt 410 (FIG. 3D) that includes added or enhanced instructions 414 (FIG. 3D) and/or added or enhanced clarifications 416. The LLM 1.11 at the general server 126 generates the new candidate prompt 410 (FIG. 3D) (which is an improved version of the initial answer prompt 400 (FIG. 3B)) in any suitable manner, such as for example using a Monte Carlo process, and tries to iteratively improve, step 3.8, where the prompt can be run on thousands of QA pairs in a loop format.

That new candidate prompt 410 can, for example, insert the question “K” from the QA pair 260, the initial answer prompt 400, as well as have more (or enhanced) detailed instructions 414, the document text 206, and more (or enhanced) clarifications 416, such as illustrated in FIG. 3D. In some embodiments, one server can host multiple models, but it is often more expensive to use larger GPUs, and having multiple servers 106, 107, 108, 124, 126, 127, 128 is also more efficient as it lets us scale the nodes separately in response to varying demand, which is different for each use case. To clarify, the judge on server 127 only does judging of the answers. The general model for RAG on server 126 can do a lot of things, including the prompt rewriting. Of course, the operation of the servers 126, 127 can be switched or combined.

These new candidate answer prompts 410 (FIG. 3D) from the LLM server 126 as well as the QA pair, step 3.2, that gave an unacceptable answer, are passed back to step 3.2 for another test. Step 3.4 on server 127 uses the new candidate prompt to ascertain whether a better answer is obtained by utilizing the Answer Judge 1.10, as shown in FIG. 3D. A per-question attempt threshold (e.g., default 3 attempts for that question), as well as an overall limit on the number of improvements (default 1000), is set by default to avoid the system running for an infinite period without finding a stable, optimal prompt. Once a candidate prompt is accepted, it becomes the optimized answer prompt 410 (FIG. 3D).

It is further noted that all questions from the QA pairs in the QA DB are tested at least once. Thus, regardless of whether an answer is determined to be acceptable or unacceptable, the steps 3.2-3.6 are repeated until all of the questions from the QA DB 134 have been analyzed. If an answer is acceptable, no change is made to the answer prompt 400. If an answer is unacceptable, the answer prompt 400 is improved by including the added or enhanced conditions, such as instruction enhancement 414 and/or clarification enhancement 416 (FIG. 3D). Those enhancements are made on an ongoing basis as each answer is determined to be unacceptable. Unacceptable answers are repeated up to a predetermined number of times (1-3); and if those are still unacceptable, an alert can be generated and the question can be discarded, ignored, or corrected by an analyst/expert.

FIG. 3D shows an example optimized answer prompt 410 (e.g., a “candidate” answer prompt that is determined to be “acceptable” at step 3.6). It includes optimized answer prompt instructions 411, optimized answer prompt document to analyze 412, and optimized answer prompt clarifications 413, which operate similar to the initial answer prompt to provide guidelines to the answer generated by the optimized answer prompt 410. The variable “K” in the optimized prompt instructions 411 represents the location where the end-user's actual question is inserted, whereby the optimized answer prompt 410 runs on each document, one at a time, as the documents to analyze 412. In addition, the optimized answer prompt instructions 411 contain added or enhanced instruction limitations 414, and the optimized prompt clarification 413 contain added or enhanced clarification limitations 416. Those added or enhanced conditions 414, 416 (which are shown underlined and italicized only to better illustrate the example embodiment) can be, for example, requirements, limitations, restrictions, guidelines or other circumstances that enable the answer prompt to achieve better results. Comparing FIGS. 3B and 3D, the added or enhanced conditions 414, 416 are not contained in the initial answer prompt 400, and improve the answers that are generated by the initial answer prompt 400. While the added or enhanced conditions 414, 416 are only shown being added to the instructions 411 and clarifications 413, other suitable conditions can be applied, such as referring to other documents.

This entire process can be initiated manually or automatically at predetermined periods (e.g., once per week) to further tune the LLM internal prompts on evolving questions. Having this option is helpful because an expert may know they just added a number of questions on new topics that may be difficult to the model, but we may not necessarily need the lengthy optimization process to run for each knowledge update that may happen every second.

For example, answer prompts 400 can be generated if the actual knowledge database 132 changes due to external influence. With Medicare, this would be annual changes they make to coverage. For example, this year they lowered covered for colorectal exams to 45 years from 50 years, so the KB 132 would need an update. If there was a QA pair 260 on “What age can I get a colorectal exam?”, that would need to be updated as well and then we might want to optimize again. This optimization process adjusts the internal prompts used in the system so that they can accommodate new scenarios, unusual occurrences, or additional steps that might need to be undertaken as the knowledge base changes. These instructions are not specific to one specific document (as there are often thousands), but often simply get longer over time as more scenarios manifest and more contingencies or exceptions are needed. FIG. 3D depicts this visually, with the new addition language 404 highlighted by italics and underlining. This text was added because the scope of this example is Medicare Parts A and B (“traditional fee for service Medicare”) and not the optional Medicare Advantage program which comes from private insurers and may have varying coverage that is outside the scope of the Federal government's purview.

It is noted that the QA pairs are not directly used in question answering to users but only utilized to test the efficacy of the initial (and candidate) answer prompts 400 in answering questions to derive the optimized answer prompt 410 (FIG. 3D) with the added or enhanced instructions 414 and added or enhanced clarifications 416. The initial and candidate answer prompts 400 keep changing (as depicted in FIG. 3D) based on how well it answers the test questions as compared to the known answer, e.g., the answer as depicted with the analyst QA pair 262. The optimized prompt 410 represents an improved answer prompt to obtain an improved answer in response to an end-user question.

### End-User Operation: Self-Optimizing RAG, FIG. 4

So far, we have focused on processes as described on FIGS. 2 and 3, which are run behind the scenes and before any end-user processing devices 102 interact with the system. Those pre-processing steps are undertaken to ensure maximum performance for questions submitted by the end-user.

Turning to FIG. 4, an example is given of an actual operational process following the operations of FIGS. 2, 3. It begins with an end-user on their device 102 asking a question, step 4.1, to the subsystem public processing device 106. This personal device 102 may be a personal computer, mobile device, voice assistant (e.g., Alexa, Siri), or similar computing device. The end-user is authenticated by the main back-end server 124 (FIG. 1). This question from the end-user is sent via the network 122 to the public processing device 106. An information retrieval process, step 4.2, starts on the public server 106, which searches the KB database 132 for related documents. Related documents 200 (e.g., the top 1-3 related documents 200) from the KB 132 are retrieved by a public program 1.6 on the public server 126, step 4.3. The public server program 1.6 then automatically and dynamically populates the optimized answer prompt 410 (FIG. 3D) with the related documents 200, step 4.5, as in FIG. 3A, to generate an answer for based on a suitable number of documents, such as one to three relevant documents. Here, the question “K” is the question being asked by the end-user. This populated optimized answer prompt 410, step 4.4, is passed to a general purpose LLM 126 to perform the RAG process, step 4.6, that creates an answer given the retrieved documents from step 4.3 and the optimized answer prompt 410, step 4.5.

It is noted that in the example embodiment, only a single optimized answer prompt 410 is utilized, which was determined based on all the QA pairs. However, that optimized answer prompt 410 is only executed based on the relevant KB documents 200, only a single optimized answer prompt 410 is needed. That is, the optimized answer prompt 410 is based on the question of whether Medicare covers carotid artery resection is covered (the first record 256 in FIG. 2C), as well as whether Rheumatoid Arthritis is covered (the second record 256 in FIG. 2C), and the other hundreds or thousands of questions in the QA DB 250. If the user is now asking whether Medicare covers carotid artery resection, the single optimized answer prompt 410 is only executed on the 1-3 best related documents that are related to carotid artery (such as the first example document record 200 in FIG. 2B), and not on unrelated documents (such as the second-seventh example document records 200 in FIG. 2B).

It will be recognized, however, that in other embodiments, there can be more than one optimized answer prompts 410, such as a first optimized answer prompt for carotid artery resection and a second optimized answer prompt for Rheumatoid Arthritis, etc., and the system can search, step 4.2, for related optimized answer prompts and run that optimized answer prompt against retrieved records.

This approach has several benefits, including:
1. The QA pairs 260 have been prepared by an expert and entered into a DB where they can be transparently reviewed. These can serve as initial examples to help test and improve the system's performance but are also templates for the subsequent step of generating automated-generated QA pairs, where their impact is multiplied.
2. The QA pairs 260 have been extensively augmented by the process on FIG. 2 to generate many more questions, which can be reviewed (but do not have to be authored by an expert). This much larger step makes optimization much easier, as we can easily go from a dozen handmade examples to thousands, and many automated optimization techniques require a large number of examples to fully work. For machine learning or systems development, more testing examples gives more thorough testing of different scenarios and more possibilities for discovering problems in the lab, before an end-user encounters them.
3. The QA pairs 260 have been automatically tested ahead of time by the auto answer prompt process on FIG. 3A. And, the optimized answer prompt has also been optimized for better performance.

Together, all parts of R.A.G. have been improved—the data Retrieved has been reviewed, the Augmentation is now assisted by AI, and the prompt Generation has been both tested and improved open by AI.

A proposed answer to the new end-user question is generated and passed over the network to a separate quality control panel which will review the proposed answer. Technically, this comprises one or more copies of the answer judge LLM 1.10 at the answer server 127, step 4.7. This same model can be used for answer quality control because it is only being used for inference, not training, and has no “memory” of what it was previously given. This quality control process is similar in nature to the judge LLM 127 referenced in step 3.5, but with two differences. First, it is performing a just-in-time quality check that the new answer is substantiated by the information in step 4.3. And second, we use an ensemble model technique (like a jury of several people in a jury trial) to evaluate the question and answer multiple times.

Taking advantage of the fact that our trained LLMs do not inherently store long term memories by themselves, we pose the same answer-verification prompt several times to the model 1.10 at the answer server 127: “The user has asked this question: <QUESTION>. We propose this answer: <ANSWER> based on this background: <RETRIEVAL FROM KNOWLEDGE BASE>. Does the answer seem reasonable given the information?” The quality control panel then records each response (e.g. five person jury-Yes, No, Yes, Yes, Yes) and calculates the rate of Yes to get a rough indication of the certainty of the decision, equating to an “ensemble” model. We then set the decision level requirements on a configurable level adjusted to the problem at hand. For example, if we find in testing that the model is consistently right 80% of the time, this quality control panel would run with a panel of five virtual jurors, and we can either require consensus for very high certainty, or take the majority opinion and still receive a much higher level of certainty than if we simply had one judge in the quality panel. These judges can be run in parallel on separate GPUs to avoid extending the amount of computation time required or on one server 127 for cost efficiency.

If the quality control panel of LLMs 127, step 4.7, determines the answer meets the decision certainty requirements and seems to match the information retrieved from step 3.2, then the answer is stored in the QA pair DB, step 4.8, and sent back to the user's device 102, step 4.9, for them to read and act on.

If the quality control panel, step 4.7, determines the answer is unsatisfactory (“bad”), a separate workflow starts. Depending on the specific project needs, the answer may be forwarded to a human expert, step 4.10, to answer, similar in fashion to how a level 2 or level 3 help desk handles tougher questions that level 1 cannot answer. This would likely require an entirely separate network session and other system for inviting a Human In The Loop (HITL) process with contact center software. Once they have reviewed the question and the material found, they could use a keyboard, voice recognition software, or similar input method to enter an alternative answer to be passed back, step 4.11, to the end-user. Alternatively, if a human is not available, a message (step 4.12) could be sent back to the user that an automated answer cannot be given to this question and they should attempt other means to answer their question.

### CONCLUSION

The system enables an organization (e.g., a company, government agency) that wishes to have an automated system for answering questions from outsiders. To set up the present system, they must install the software, hardware, and follow the processes previously described to create the knowledge base and example questions. Once the system is setup, it generally manifests on a computer. A person uses their voice, keyboard, or touchscreen to enter a question, and the question is sent to the system electronically. The system then searches the knowledge base for information, formulates an answer, and sends it back to the user.

The system 100 can be used in a number of ways. It can be used at contact centers for health, technology, financial, consumer, or other services. It can supplement some of the work currently done by level 1 support personnel. It can provide more intelligent self-service customer support, as currently available on most consumer facing websites. And, it can provide business to business support (e.g., for medical insurers who provide support lines to professional like doctors who wish to bill them).

The system 100 provides a mixture of human intelligence, search, and other AI to give the LLMs access to highly accurate information on a topic. Instead of predicting the likely answer from nothing, they are using an internal knowledge base 132 and many optimizations to summarize the right answer from a curated set of knowledge. Our system is unique as it combines a number of AI and data enhancement techniques into an automated process from knowledge gathering, all the way through providing an answer. The system improves on standard question answering systems with RAG, with both pre-processing of the data and post-processing to further enhance the optimization of the automated system.

The combined improvements work together to improve upon prior art and their use in isolation. In effect, some parts compensate for shortcomings of others:
1. The present system, having access to all the technical improvements and working synergistically together, is much more accurate in testing against much larger models working in isolation. Our testing has shown accuracy improvements of over 20% against much larger LLMs (e.g., OpenAI's GPT-4, which is estimated to be 1.8 trillion parameters vs. the 56 billion we use). Were we to use similarly large models, we would likely have even better accuracy.
2. By using the knowledge base and RAG approach, the present system is much more configurable and up to date. The system can dynamically change facts in the knowledge base and have that new information show up in user queries in real-time within a second. Lone LLMs must be retrained to get new information in, which can take months. OpenAI currently releases model updates publicly once a year in January, while the present system can dynamically update knowledge in real time. In this system, standard database indexes present on the knowledge base 132 take about a second to update and are then ready to use by the information retrieval process.
3. By only requiring a knowledge base and a sample of testing questions, the system is much simpler and requires less storage and curation than prior systems that required a separate, comprehensive QA DB to cover all possible customer questions. Our system is optimized to answer novel questions by reading the source material, formulating a novel answer, quality checking it, and then presenting it to a user. Other systems must constantly keep up to date a Frequently Asked Questions list in parallel to their official knowledge base to cover all eventualities over time.
4. By having a well-optimized RAG prompt specific to the topic and actual questions, the present system is much more compliant and on topic. Instead of asking the LLM a random question and hoping it responds, the present system is repeatedly tested with relevant questions and tuned to stay on topic. We then check for compliance before returning. This greatly reduces hallucinations (on the same 20%+ order) in our prototype.
5. Unlike other RAG solutions, the present system is largely self-updating with knowledge. After a human pre-populates the QA database with ten to twenty examples, the present system can automatically generate thousands or tens of thousands of usable questions and answer pairs. Most other solutions require hand curation of this data, taking thousands of human hours.
6. Unlike other RAG solutions, the present system is self-optimizing. Rather than requiring “prompt engineering” with trial and error as is common, the present system uses an LLM to optimize the prompts used internally, automatically test them, and then iterate upon this for automated improvements.
7. Unlike prior art with RAG, the present system has built-in automated quality assurance. Rather than simply generating an answer that we hope is accurate, we massively test answers beforehand (in the optimization process) but also at runtime with the judging panel. Furthermore, questions that pass and fail from this judging panel are reused to feed the self-optimization process, meaning use of the system by real-world users also automatically improves it.

The present system 100 overcomes a number of problems faced by prior systems, including:
Questions are answered only from stock answers. Unlike the present system, those earlier systems lacked an LLM to rephrase the answer in terms of the question.
Unlike the present system, prior systems were not self-optimizing for a domain and tried to be one size fits all and are not capable of optimizing for different scenarios.
Unlike the present system, prior systems often relied only on keyword search and did not have any capabilities for semantic understanding. This would be exemplified by older search engines where you searched for “NYC” and the system did not recognize that had the same meaning as “New York City”.

Thus, the system has QA pairs that are flexible, do not need a close or precise match of the question, are less prone to mismatch, and can account for abbreviations, differences in dialect, differences in speech pattern. The system can be used in any industry that would benefit from written knowledge about how to perform knowledge work. Insurance, healthcare, data processing, law, real estate, safety.

The system and method of the present disclosure include operation by one or more processing devices, including the user interfaces 102, 103, 104, the web apps 106, 107, 108, and the server 120. It is noted that the processing device can be any suitable device, such as a computer, server, mainframe, processor, microprocessor, PC, tablet, smartphone, or the like. The processing devices can be used in combination with other suitable components, such as a display device (monitor, LED screen, digital screen, etc.), memory or storage device, input device (touchscreen, keyboard, pointing device such as a mouse), wireless module (for RF, Bluetooth, infrared, WiFi, etc.). The information may be stored on a computer hard drive, solid state disk, or on any other appropriate data storage device, which can be located at or in communication with the processing device, such as the KB 132 and the QA DB 134. The entire process is conducted automatically by the processing device, and without any manual interaction. Accordingly, unless indicated otherwise the process can occur substantially in real-time without any delays or manual action.

As used herein, when an element or feature is described as being “configured,” that element or feature is structurally arranged or formed to accomplish the stated purpose. As used with respect to a processing device (e.g., computer), the term “configured,” “configured with,” or “configured to” means that the processing device is structurally arranged or ordered (e.g., by supplying, arranging or connecting a specific set of internal or external components or modules, for example that perform certain operations) to accomplish the stated purpose or task.

The foregoing description and drawings should be considered as illustrative only of the principles of the disclosure. The system may be configured in a variety of ways and is not intended to be limited by the preferred embodiment. Numerous applications of the system will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1. An information retrieval and summarization system, comprising:
a knowledge database configured to store a plurality of data records, each of said plurality of data records having a data document ID, data document title, data source link, and data document text retrieved from said data source link;
a question and answer (QA) database configured to store a QA ID, QA title, and an analyst-generated question and answer (QA) pair, said analyst-generated QA pair having an analyst-generated question and an analyst-generated answer associated with the analyst-generated question;
a custom QA prompt database configured to store a QA prompt record, said QA prompt record including a QA prompt instruction, QA prompt clarification, and a QA predefined prompt example; and
a QA generation processing device configured to apply said QA prompt record to the data document text stored in said knowledge database to generate a plurality of automated-generated QA pairs using a large language model, and store said plurality of automated-generated QA pairs in said QA database, said plurality of automated-generated QA pairs each having an automated-generated question and an automated-generated answer associated with the automated-generated question.

2. The system of claim 1, further comprising:
an answer prompt optimization processing device configured to execute a candidate answer prompt that retrieves all of the user-generated question and automated-generated questions from said QA database, to:
(a) apply all of the retrieved analyst-generated question and automated-generated questions to the data document text stored in said knowledge database to generate a candidate answer using retrieval-augmented generation, compare the candidate answer to said analyst-generated answer associated with the retrieved analyst-generated question to determine if the candidate answer is acceptable;
(b) if the candidate answer is acceptable, identify said candidate answer prompt as an optimized answer prompt;
(c) if the candidate answer is not acceptable, rerun (a) and (b) on the candidate answer prompt up to a predetermined number of times to obtain updated candidate answer(s); and
(d) if the updated candidate answer(s) is still not acceptable, generate an alert.

3. The system of claim 2, wherein said updated candidate answer prompt includes an added or enhanced condition.

4. The system of claim 2, wherein said updated candidate answer prompt includes answer prompt instructions and answer prompt clarifications, and the added or enhanced condition comprises an added or enhanced answer prompt instruction and/or an added or enhanced answer prompt clarification.

5. The system of claim 2, further comprising:
a general processing device configured to:
receive an end-user question from an end-user, search said knowledge database for relevant data records relevant to the end-user question amongst the plurality of data records;
apply the optimized answer prompt to the end-user question for each of the relevant data records to generate an end-user answer; and
return the end-user answer to the end-user.

6. The system of claim 5, wherein the end-user question is entered by an end-user at an end-user processing device.

7. The system of claim 5, wherein said QA generation processing device, said answer prompt optimization processing device and said general processing device comprise a same processing device.

8. An information retrieval and summarization system, comprising:
a knowledge database configured to store a plurality of data records, each of said plurality of data records having a data document ID, data document title, data source link, and data document text retrieved from said data source link;
a question and answer (QA) database configured to store a plurality of question and answer (QA) pairs each having a question and an answer associated with the question;
an answer prompt optimization processing device configured to execute a candidate answer prompt that retrieves all of the questions from said QA database, to:
(a) apply all of the retrieved questions to the data document text stored in said knowledge database to generate a candidate answer using retrieval-augmented generation, compare the candidate answer to said answer associated with the question to determine if the candidate answer is acceptable;
(b) if the candidate answer is acceptable, identify said candidate answer prompt as an optimized answer prompt;
(c) if the candidate answer is not acceptable, rerun (a) and (b) on the candidate answer prompt up to a predetermined number of times to obtain updated candidate answer(s); and
(d) if the updated candidate answer(s) is still not acceptable, generate an alert.

9. The system of claim 8, wherein said updated candidate answer prompt includes an added or enhanced condition.

10. The system of claim 8, wherein said updated candidate answer prompt includes answer prompt instructions and answer prompt clarifications, and the added or enhanced condition comprises an added or enhanced answer prompt instruction and/or an added or enhanced answer prompt clarification.

11. The system of claim 8, further comprising:
a general processing device configured to:
receive an end-user question from an end-user, search said knowledge database for relevant data records relevant to the end-user question amongst the plurality of data records;
apply the optimized answer prompt to the end-user question for each of the relevant data records to generate an end-user answer; and
return the end-user answer to the end-user.

12. The system of claim 11, wherein the end-user question is entered by an end-user at an end-user processing device.

13. The system of claim 11, wherein said QA generation processing device, said answer prompt optimization processing device and said general processing device comprise a same processing device.

14. An information retrieval and summarization system, comprising:
a knowledge database configured to store a plurality of data records, each of said plurality of data records having a data document ID, data document title, data source link, and data document text retrieved from said data source link;
a general processing device configured to:
receive an end-user question from an end-user, search said knowledge database for relevant data records relevant to the end-user question amongst the plurality of data records;
apply an answer prompt to the end-user question only to each of the relevant data records to generate an end-user answer, wherein said answer prompt is optimized over time to include an added or enhanced condition; and
return the end-user answer to the end-user.

15. The system of claim 14, wherein said answer prompt includes answer prompt instructions and answer prompt clarifications, and the optimized answer prompt further comprises an added or enhanced answer prompt instruction and/or an added or enhanced answer prompt clarification.

16. The system of claim 14, wherein the end-user question is entered by an end-user at an end-user processing device.
